(19) United States
(12) Patent Application Publication
(10) Pub. No.: US 2023/0199614 A1
(43) Pub. Date: Jun. 22, 2023

(54) METHODS AND APPARATUS OF SIDELINK RELAY BASED DATA TRANSMISSION WITH MULTIPLE PATHS

(71) Applicant: MediaTek Singapore Pte. Ltd., Singapore (SG)

(72) Inventors: Xuelong Wang, Beijing (CN); Nathan Edward Tenny, San Jose, CA (US); Guan-Yu Lin, Hsinchu City (TW)

(21) Appl. No.: 18/059,355

(22) Filed: Nov. 28, 2022

Related U.S. Application Data
(63) Continuation of application No. PCT/CN2021/138729, filed on Dec. 16, 2021.

(30) Foreign Application Priority Data
Oct. 28, 2022 (CN) CN 202211335290.6

(51) Int. Cl. H04W 40/22; H04W 40/12

(52) U.S. Cl. CPC H04W 40/22; H04W 40/12

(57) ABSTRACT

Apparatus and methods are provided for sidelink relay based data transmission with multiple paths. In one novel aspect, multiple transceiving paths is established between a source node and a destination, wherein at least one path includes a sidelink connection with a relay node. The sidelink relay adaptation protocol (SRAP) layer or the PDCP layer of the source node performs data split or data duplication for egress data packets before delivering the egress data to multiple corresponding RLC entities. The source node aggregates ingress data packets received from the multiple transceiving paths at the source node. In one embodiment, one transceiving path among the multiple transceiving paths is selected as a primary path. In one embodiment, the source node performs data split or data duplication at the SRAP layer per packet or per RB. In another embodiment, the source node performs data split or data duplication based on a preconfigured threshold.

### CROSS REFERENCE TO RELATED APPLICATIONS

This application is filed under 35 U.S.C. §111(a) and is based on and hereby claims priority under 35 U.S.C. §120 and §365(c) from International Application No. PCT/CN2021/138729, titled “Methods and apparatus of Sidelink Relay Based Data Transmission with Multiple Paths,” with an international filing date of Dec. 16, 2021. This application claims priority under 35 U.S.C. §119 from Chinese Application Number CN 202211335290.6 titled “Methods and apparatus of Sidelink Relay Based Data Transmission with Multiple Paths,” filed on Oct. 28, 2022. The disclosure of each of the foregoing documents is incorporated herein by reference.

### TECHNICAL FIELD

The disclosed embodiments relate generally to wireless communication, and, more particularly, to sidelink based data transmission with multiple paths.

### BACKGROUND

Various cellular systems, including both 4G/ long term evolution (LTE) and 5G/ new radio (NR) systems, may provide a relaying functionality, which allows a remote user equipment (UE) in the system to communicate with the cellular system based on data forwarding supported by a relay UE. A variety of applications may rely on communication over relaying link between the remote UE and the network, such as FTP data services, the voice call, the vehicle-to-everything (V2X) communication, public safety (PS) communication, and so on. In some cases, there may be a need for the cellular system to enable multipath based transmission between the remote UE and the cellular system to ensure the transmission reliability and/or to maximize the throughput between the source node and the destination node.

Multipath configuration provides reliability and increases throughput for data traffic. With the development of relay links, multipath with relay links provides more flexibility with different configurations. With the increased complexity, the process of data transmission and reception, including data split, data duplication, and data aggregation, requires protocol layer implementation and interface definitions among protocol layers.

Improvements and enhancements are required to support multipath with sidelink relay data transmission.

### SUMMARY

Apparatus and methods are provided for sidelink relay based data transmission with multiple paths. In one novel aspect, multiple transceiving paths is established between a source node and a destination, wherein at least one path includes a sidelink connection with a relay node. The sidelink relay adaptation protocol (SRAP) layer or the packet data convergence protocol (PDCP) layer of the source node performs data split or data duplication for egress data packets before delivering the egress data to multiple corresponding radio link control (RLC) entities of the source protocol stack. The source node aggregates ingress data packets received from the multiple transceiving paths at the source node. The multiple paths can be established before the data transmission. The multiple paths can be updated by adding, modifying, or deleting one or more paths before or after the data transmission starts. In one embodiment, all multiple paths are equally weighted. In another embodiment, one transceiving path among the multiple transceiving paths is selected as a primary path. In one embodiment, when the multiple transceiving paths include a direct path between the source node and the destination, the direct path is selected as the primary path. In another embodiment, the primary path is selected based signal qualities of the multiple transceiving paths. In yet another embodiment, SRAP control packet data units (PDUs) are transmitted through the primary path. In one embodiment, the source node performs data split or data duplication at the SRAP layer per packet or per resource block (RB). In another embodiment, the source node performs data split or data duplication based on a preconfigured threshold.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network that supports sidelink relay based data transmission with multiple paths in accordance with embodiments of the current invention.

FIG. 2A illustrates an exemplary NR wireless system with centralized upper layers of the NR radio interface stacks and UE stack with multicast protocol and unicast protocol in accordance with embodiments of the current invention.

FIG. 2B FIG. 2B illustrates exemplary top-level functional diagrams sidelink relay based data transmission with multiple paths in accordance with embodiments of the current invention.

FIG. 3 illustrates exemplary diagrams of a UE-to-Network (U2N) with an integration of relay UE between the base station and the remote UE for traffic forwarding in accordance with embodiments of the current invention.

FIG. 4 illustrates exemplary diagrams a UE-to-UE (U2U) in accordance with embodiments of the current invention.

FIG. 5A illustrates an exemplary user plane protocol architecture for NR UE-to-Network relay network, in accordance with embodiments of the current invention.

FIG. 5B illustrates an exemplary control plane protocol architecture for NR UE-to-Network relay network, in accordance with embodiments of the current invention.

FIG. 6 illustrates exemplary diagrams of a UE-to-Network relay network with multiple paths in accordance with embodiments of the current invention.

FIG. 7 illustrates exemplary diagrams of a UE-to-UE relay network with multiple paths in accordance with embodiments of the current invention.

FIG. 8A illustrates exemplary diagrams for UE-to-Network relay network with multiple paths where the data split and/or data aggregation being performed at the SRAP sublayer in accordance with embodiments of the current invention.

FIG. 8B illustrates exemplary diagrams for UE-to-Network relay network with multiple paths where the data split and/or data aggregation being performed at the PDCP sublayer in accordance with embodiments of the current invention.

FIG. 9 illustrates exemplary diagrams for UE-to-UE relay network with multiple paths in accordance with embodiments of the current invention.

FIG. 10 illustrates an exemplary diagram for alternative implementations to configure sidelink relay based multipath data transmission in accordance with embodiments of the current invention.

FIG. 11 illustrates an exemplary flow chart for the sidelink relay based data transmission with multiple paths in accordance with embodiments of the current invention.

### DETAILED DESCRIPTION

Reference will now be made in detail to some embodiments of the invention, examples of which are illustrated in the accompanying drawings.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Several aspects of telecommunication systems will now be presented with reference to various apparatus and methods. These apparatus and methods will be described in the following detailed description and illustrated in the accompanying drawings by various blocks, components, circuits, processes, algorithms, etc. (Collectively, referred to as “elements”). These elements may be implemented using electronic hardware, computer software, or any combination thereof. Whether such elements are implemented as hardware or software depends upon the particular application and design constraints imposed on the overall system.

Aspects of the present disclosure provide methods, apparatus, processing systems, and computer readable mediums for NR (new radio access technology, or 5G technology) or other radio access technology. NR may support various wireless communication services. These services may have different quality of service (QoS) requirements e.g., latency and reliability requirements.

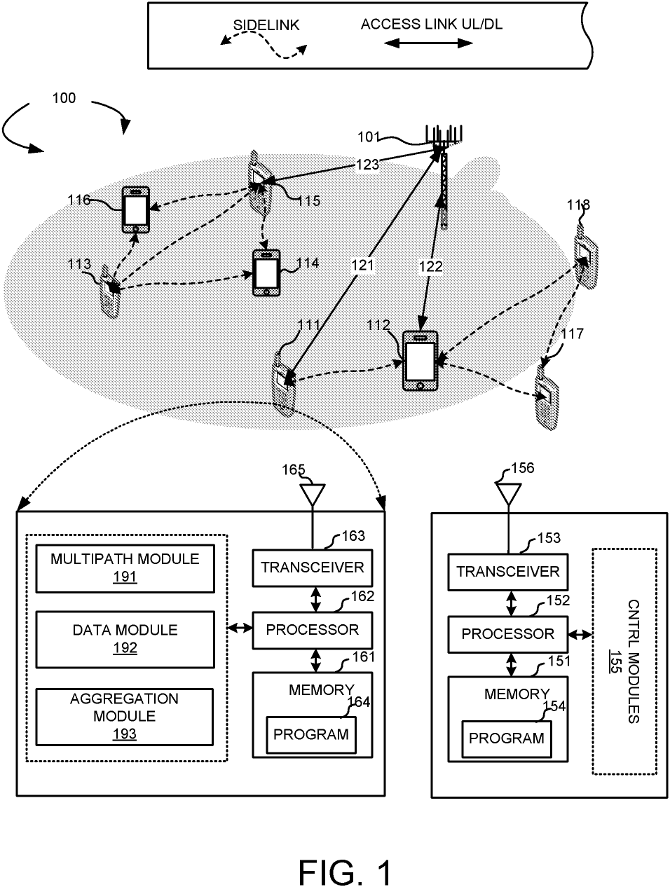

FIG. 1 is a schematic system diagram illustrating an exemplary wireless network that supports sidelink relay based data transmission with multiple paths in accordance with embodiments of the current invention. Wireless network/system 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. The network can be homogeneous network or heterogeneous network, which can be deployed with the same frequency or different frequency. gNB 101 is a base station in the NR network, the serving area of which may or may not overlap with other base stations (not shown) in the wireless network.

Wireless network 100 also includes multiple communication devices or mobile stations, such as user equipments (UEs) 111, 112, 113, 114, 116, 117, and 118. The UE may also be referred to as mobile station, a mobile terminal, a mobile phone, smart phone, wearable, an IoT device, a table let, a laptop, or other terminology used in the art. The exemplary UEs 111 to 118 shown in wireless network 100 also apply to devices with wireless connectivity, such as a vehicle. The communication devices can establish one or more connections with one or more base stations. For example, UE 111 has Uu link 121 with gNB 101. Similarly, UEs 112 and 115 has Uu links 122 and 123 connecting with gNB 101, respectively. The mobile device, such as UE 117 and UE 118, may also be out of connection with the base stations with its access links but can transmit and receive data packets with another one or more other mobile stations or with one or more base stations through sidelink relay.

In one novel aspect, multipath data transmission with sidelink relay is configured and established. The remote UE / source node performs data transmission and reception with a destination node, which can be a base station or another UE. The multiple paths include at least one relay link with a relay node. The source node establishes sidelink/PC5 connection with the relay node. In one scenario, the remote UE is out of range. The out-of-range UE, such as UE 117 and UE 118 can establish communication with the base station through a relay UE, such as UE 112. Out-of-range UE can also establish sidelink with each other. In one embodiment, source of the data transmission, the remote UE, such as UE 111 or UE 113, performs data split at its SRAP (sidelink relay adaptation protocol) sublayer before the data is delivered to the first radio link control (RLC) entity (corresponding to the direct path) and the second RLC entity (corresponding to the indirect path). In another embodiment, the source of the data transmission, the remote UE, such as UE 111 or UE 113, performs data split at its PDCP sublayer before the data is delivered to the first radio link control (RLC) entity (corresponding to the direct path) and the second RLC entity (corresponding to the indirect path).Then the data is sent from remote UE to the base station or another remote UE via two paths separately. The said data packets split by SRAP can be SRAP data PDU, or the data corresponding to the PDCP data PDU. The said data packets split by PDCP can be the PDCP data PDU. The receiving node of the data (i.e., the base station or another remote UE) performs data combination at PDCP layer. In another aspect of the disclosure, as the source of the data transmission, the remote UE, such as UE 111 or UE 113, can perform data duplication at its PDCP sublayer or SRAP sublayer before the data is delivered to Uu RLC entity (corresponding to the direct path) and PC5 RLC entity (corresponding to the indirect path). Then the same data packets are simultaneously sent from remote UE to the destination node via two paths separately. The receiving node of the data, such as gNB 101 or UE 115, can perform duplicates removal at PDCP sublayer.

FIG. 1 further illustrates simplified block diagrams of a base station and a mobile device/UE for sidelink relay based data transmission with multiple paths. gNB 101 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 101. Memory 151 stores program instructions and data 154 to control the operations of gNB 101. gNB 101 also includes a set of control modules 155 that carry out functional tasks to communicate with mobile stations.

FIG. 1 also includes simplified block diagrams of a UE, such as UE 111. The UE has an antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown). RF transceiver 163 also converts received baseband signals from processor 162, converts them to RF signals, and sends out to antenna 165. Processor 162 processes the received baseband signals and invokes different functional modules to perform features in UE 111. Memory 161 stores program instructions and data 164 to control the operations of UE 111. Antenna 165 sends uplink transmission and receives downlink transmissions to/from antenna 156 of gNB 101.

The UE 111 also includes a set of control modules that carry out functional tasks. These control modules can be implemented by circuits, software, firmware, or a combination of them. A multi-path module 191 establishes multiple transceiving paths between the UE (e.g. remote UE) and a destination node (e.g. gNB) in the wireless network, wherein at least one transceiving path includes a sidelink connection with a relay node (e.g. relay UE). A data module 192 performs data split or data duplication for egress data packets at SRAP layer or PDCP layer before delivering egress data packets to multiple corresponding RLC entities of the source protocol stack. An aggregation module 193 aggregates ingress data packets received from the multiple transceiving paths. In case of multiple-path based operation, the direct path and indirect path can be served by the same cell (i.e., PCell) or by different cells. In addition, the remote UE and relay UE can be served by different inter-frequency cells of the same gNB. According to some embodiments, the UE 111 further includes a path-selection module that selects one transceiving path among the multiple transceiving paths as a primary path.

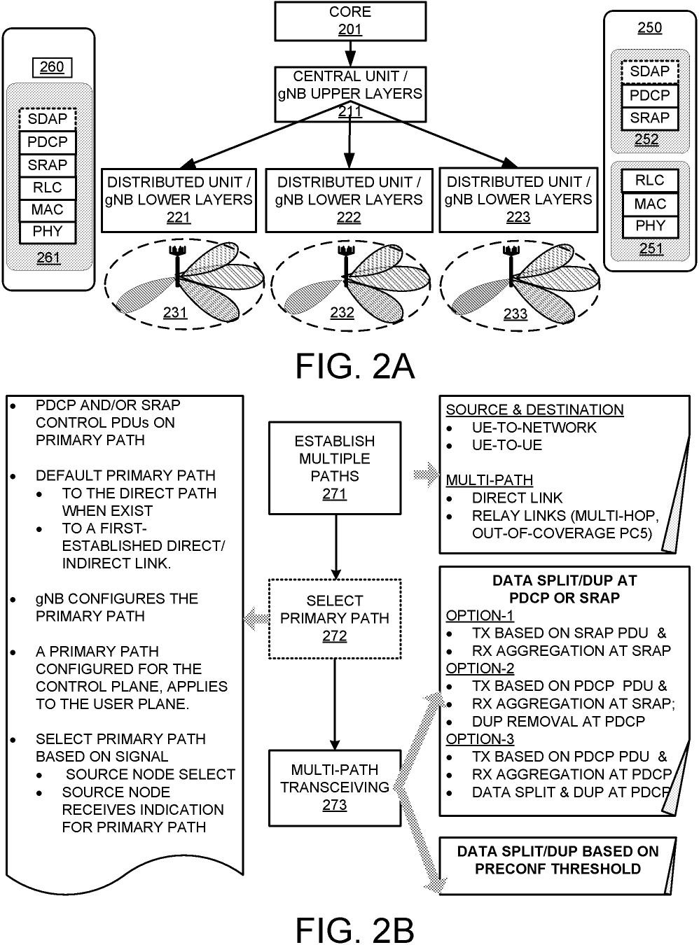

FIG. 2A illustrates an exemplary NR wireless system with centralized upper layers of the NR radio interface stacks in accordance with embodiments of the current invention. Different protocol split options between central unit (CU) and distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization, and jitter. In one embodiment, SDAP, PDCP and SRAP layer/sublayer are located in the CU, while RLC, MAC and PHY layers are located in the DU. A core unit 201 is connected with one central unit 211 with gNB upper layer 252. In one embodiment 250, gNB upper layer 252 includes the PDCP layer and optionally the SDAP layer. The gNB upper layer 252 can include SRAP layer to enable the support for Layer 2 based sidelink relay operation. Central unit 211 connects with distributed units 221, 222, and 221. Distributed units 221, 222, and 223 each corresponds to a cell 231, 232, and 233, respectively. The DUs, such as 221, 222 and 223 includes gNB lower layers 251. In one embodiment, gNB lower layers 251 include the PHY, MAC and the RLC layers. In another embodiment 260, each gNB has the protocol stacks 261 including SDAP, PDCP, SRAP, RLC, MAC and PHY layers.

FIG. 2B illustrates exemplary top-level functional diagrams of sidelink relay based data transmission with multiple paths in accordance with embodiments of the current invention. In one novel aspect, sidelink based multipath operation is supported. There are various reasons to enable multiple transmission paths (including two paths) based data transmission between the source node and the destination node during relaying operation. For example, it can improve the data throughput if the split data from the source node can reach the destination node via multiple paths. Multiple paths based data transmission may improve the transmission reliability if duplicated data packets from the source node can reach the destination node. If one source node wants to communicate with the destination node, when transmitting the data to the destination node, the source node may request multiple relaying nodes to help to transmit part of the data to the destination node. The destination node can aggregate the data from the source node when the data is received from different relaying nodes.

In case of multiple transmission paths based data transmission between the source node and the destination node during relaying operation, the data packets carried by different transmission paths can be the same or different. In case of the same data packets transmitted over multiple transmission paths, the data duplication is activated at PDCP or SRAP sublayer/layer. In case of different data packets transmitted over multiple transmission paths, the data split is activated at PDCP or SRAP sublayer. Such data split and/or data duplication operation can be performed at per-packet basis or at per-radio bearer (RB) basis. In case of per-packet operation, for a given data flow (i.e., the data for an RB), some packets can be split and/or duplicated based on a selective manner, the other ones can be only transmitted at one transmission path. In case of per-RB operation, for a given data flow (i.e., the data for a RB), all packets is subject to data split and/or data duplication. During the operation of data split and/or data duplication, the data packets can be split into and/or duplicated at all of or part of the available transmission paths if multiple transmission paths are available. For example, if there are three transmission paths available, the packets may be duplicated at only at two of the three transmission paths. Depending on the transmission quality, the operation of data split, data duplication and normal data transmission (without data split and data duplication) may be interlaced, which means, the data packets can be duplicated at multiple transmission paths, e.g., because of the concern on the transmission reliability. The data packets can also be split into multiple transmission paths, e.g. because of the requirement to improve the transmission quality. And sometimes the data packets can be subject to normal data transmission (without data split and data duplication).

At step 271, multiple transceiving paths are configured and/or established between a source node and a destination node. In one novel aspect, the multiple transceiving paths include at least one path involving a sidelink with a relay node. In a UE-to-network configuration, the data from the source node may transmit to the destination node via both a direct path and one or more indirect paths simultaneously. The same motivation is applicable to UE-to-UE based relaying network as well as to the hybrid network involving both UE-to-Network based relaying network and UE-to-UE based relaying network, which may include multi-hop relaying and mesh type network. Accordingly, each of the source and destination may be a UE or a network node, and intermediate relay nodes that transmit packets in flight between the source and the destination may be UEs, network nodes, or a combination of the two.

In these cases, it is beneficial to specify the exact data transmission mechanism within a protocol layer between the involved interfaces, which helps the source and destination node to utilize the relaying link to perform data transmission. At step 273, transmission and reception of data packets using the multiple paths is performed. In one aspect, data split or data duplication is performed at the PDCP or SRAP layer of the source protocol stack. SRAP is a protocol layer introduced for sidelink and is placed over the RLC layer at both the PC5 interface and the Uu interface. In one embodiment of option-1, the data flow before the split needs to go across the Uu SRAP (both UL and DL) for transmission. At the Rx side, the data flow need go to the Uu SRAP (both UL and DL) for aggregation. If the data split is taken at SRAP layer, the transmitting SRAP sublayer is associated with two RLC entities (one is the PC5 RLC, and the other is the Uu RLC) for one data stream going to one destination (e.g., from a remote UE to a gNB). In another embodiment of option-2, the data split or data duplication is based on PDCP PDU. The data split or data duplication can be performed at the SRAP. Accordingly, even though the aggregation is performed at Rx SRAP, the Rx SRAP cannot detect the data loss and do duplication removal and both functions may still happen at PDCP layer since we assume the data packets during PDCP-> SRAP and SRAP->PDCP are always in-order delivery. In another embodiment of Option-3, the data split or data duplication occurs at PDCP sublayer and is based on PDCP data PDU.

In one novel aspect, a primary path is configured for the sidelink based multipath data transmission. The primary path can be defined from control plane perspective or user plane perspective or both. If the primary path is defined from control plane perspective, one or more principles in the following list may apply: (a) The primary path is the path where the remote UE has initially established an RRC connection;(b) The primary path is the path where the remote UE has re-established an RRC connection;(c) The primary path is the path configured on PCell of the remote UE. If the primary path is the indirect path, the PCell of the remote UE is same as the PCell of the relay UE;(d) The primary path is the path that is indicated by the gNB as the primary path;(e) The primary path is the path used as the AS security anchor;(f) The primary path is the path where the remote UE acquires system information;(g) The primary path is the path where the remote UE exchanges NAS messages. (h) The primary path is the path that gNB indicated for the remote UE during mobility. If the primary path is defined from user plane perspective, the primary path is used by PDCP sublayer to determine the default data transmission path.

At step 272, before the data transceiving a primary path is selected. In one embodiment, the primary path is dynamically selected. PDCP and/or SRAP control PDUs are transmitted on the primary path only. In one embodiment, a direct link or indirect link is established at the first place as one of the multiple paths for the data transmission. The direct link or indirect link is selected or default to be primary path. In another embodiment, the primary path is configured by the gNB as the direct link or the indirect link. In another embodiment, if the primary path is configured for control plane, it can also apply to user plane transmission. In another embodiment, the primary path is selected based on signal conditions. In one embodiment, the source node selects the primary path. The primary path is selected based on measurement results for the multiple paths configured. In another embodiment, the source node receives primary path and secondary paths configuration from the network or other nodes. The source node performs measurements for multiple paths and sends the measurement results. The primary path selection is based on the measurement results.

In one novel aspect, sidelink relay is established and are configured as part of the multiple paths for the data transmission between the source node and the destination node. During multiple path operation towards the network, when the source UE (e.g, remote UE) experiences radio link failure at indirect path, the data transmission on the failed path is suspended and the remote UE reports the failure status to the gNB via direct path by RRC message; when the source UE (e.g, remote UE) experiences radio link failure at direct path, the data transmission on the failed path is suspended and the remote UE reports the failure status to the gNB via indirect path by RRC message. For both cases, the multiple path operation is stopped between the UE and the network. The remote UE does not initiate RRC connection reestablishment as long as there is still one transmission path available between the UE and the network. From radio link monitoring (RLM) perspective, the UE performs RLM on both direct path and indirect path in an independent manner.

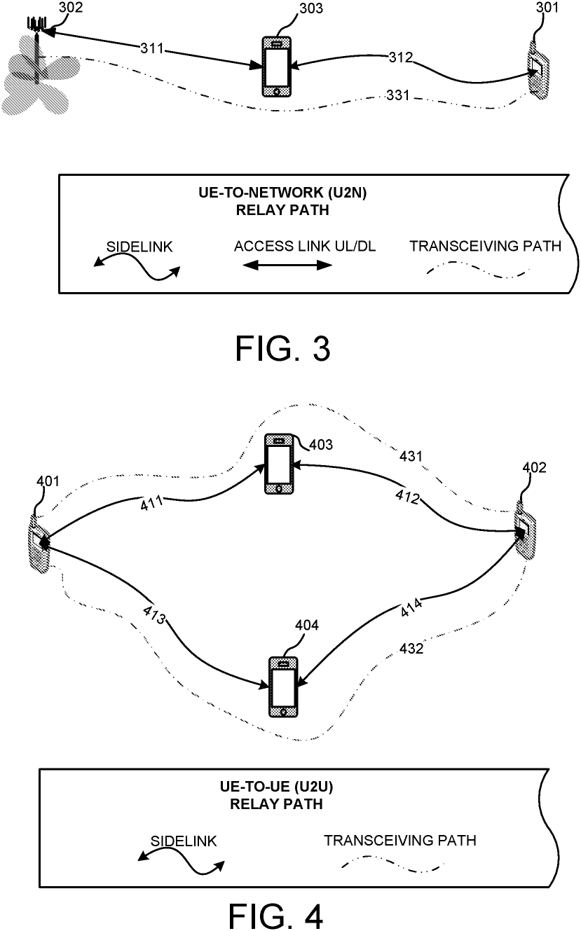

FIG. 3 illustrates exemplary diagrams of a UE-to-Network (U2N) with an integration of relay UE between the base station and the remote UE for traffic forwarding in accordance with embodiments of the current invention. A one-hop UE-to-Network relay for traffic forwarding is configured. A remote UE 301 established a relay path with a gNB 302 through a relay UE 303. Relay UE 303 communicates with gNB 302 via access link 311. Relay UE 303 communicates with remote UE 301 through sidelink 312. The sidelink is 3GPP specified radio link with PC5 interface. gNB 302 transmits data packets destined to remote UE 301 through DL to relay UE 303 and receives data packets from remote UE 301 through UL from relay UE 303. The transceiving path 331 between remote UE 301 and gNB 302 includes access link 311 and sidelink 312. In one embodiment, the U2N relay path is a layer-2 relay mode.

FIG. 4 illustrates exemplary diagrams a UE-to-UE (U2U) in accordance with embodiments of the current invention. There are two relay UEs, relay UE 403 and relay 404, located between the remote UE 401 and the remote UE 402. Relay UE 403 and relay UE 404 work at L2 relaying mode. Sidelink 411 is established between source node 401 and relay node 403. Sidelink 412 is established between destination node 402 and relay node 403. Sidelink 413 is established between source node 401 and relay node 404. Sidelink 414 is established between destination node 402 and relay node 404. Two relay paths are established. Data transceiving path 431 between UE 401 and 402 include sidelink link 411 and sidelink 412. Data transceiving path 432 between UE 401 and 402 include sidelink link 413 and sidelink 414.

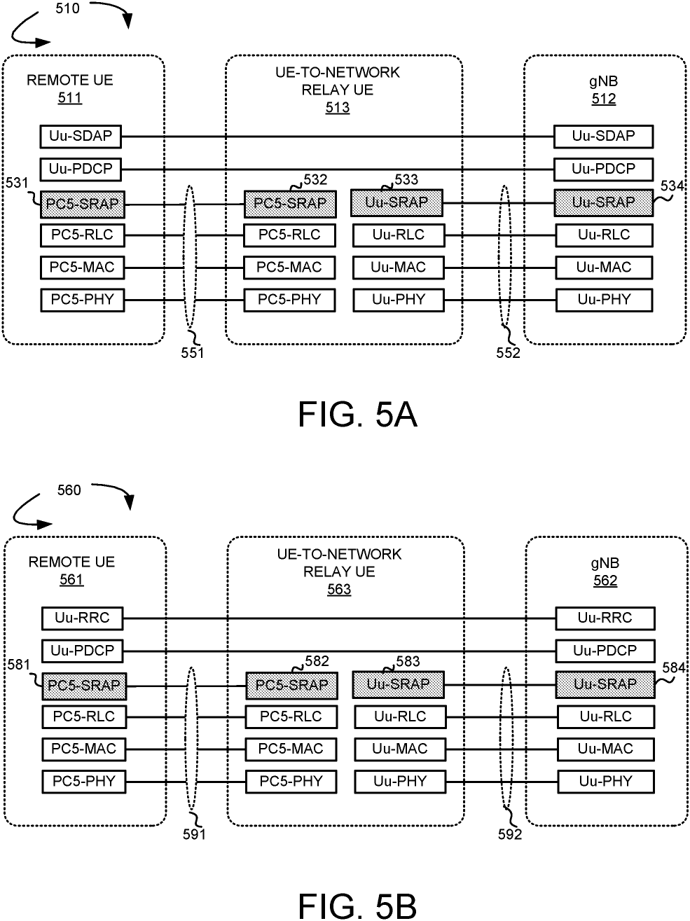

For both Layer-2 U2N and Layer-2 U2U relaying network, the relaying is performed above RLC sublayer via relay UE for both control plane (CP) and user plane (UP) between the source node and the destination node. The SDAP/PDCP and RRC are terminated between source node and destination node i.e., between a remote UE and a gNB (i.e. the Base Station) or between two remote UEs, while SRAP, RLC, MAC and PHY are terminated in each link. FIGS. 5A and 5B illustrate the protocol stacks for CP and UP.

FIG. 5A illustrates an exemplary user plane protocol architecture for NR UE-to-Network relay network, in accordance with embodiments of the current invention. An exemplary UE-to-network relay path includes a remote UE node 511, a network node 512 and a UE-to-Network relay node UE 513. In one embodiment the network node 512 is a gNB. In one embodiment, it is a central unit. In another embodiment, the network node 512 can be a 5GC and DU node. The lower layer wireless channel is established through the PHY, MAC, and RLC layers of each node on the relay path. A first wireless connection 551 is established between lower layer stack of remote UE 511 and a first lower layer protocol stacks, including PC5-PHY, PC5-MAC, and PC5-RLC of relay UE 513. A second wireless connection 552 is established between a second lower layer protocol stack, including Uu-PHY, Uu-MAC, and Uu-RLC, of relay UE 513 and a lower layer protocol stack of gNB 512. The lower layer links 552 are Uu interface channels. The lower layer links 551 are sidelink channels. Remote UE 511 also has PC5-SRAP layer 531 between RLC layer and PDCP layer. PC5-SRAP at remote UE 511 supports UL bearer mapping between remote UE Uu Radio Bearer and egress PC5 RLC channels. Relay UE 513 has a PC5-SRAP 532 connecting to remote UE 511 PC5-SRAP 531, and an Uu-SRAP 533 connecting to gNB Uu-SRAP 534. On the user plane, end-to-end protocol connection is established directly between protocol stack at SDAP and PDCP layer.

FIG. 5B illustrates an exemplary control plane protocol architecture for NR UE-to-Network relay network, in accordance with embodiments of the current invention. An exemplary UE-to-network relay path includes a remote UE node 561, a network node 562 and a UE-to-Network relay node UE 563. In one embodiment the network node 562 is a gNB. In one embodiment, it is a central unit. In another embodiment, the network node 562 can be a 5GC and DU node. The lower layer wireless channel is established through the PHY, MAC, and RLC layers of each node on the relay path. A first wireless connection 591 is established between lower layer stack of remote UE 561 and a first lower layer protocol stacks, including PC5-PHY, PC5-MAC, and PC5-RLC of relay UE 563. A second wireless connection 592 is established between a second lower layer protocol stack, including Uu-PHY, Uu-MAC, and Uu-RLC, of relay UE 563 and a lower layer protocol stack of gNB 562. The lower layer links 592 are Uu interface channels. The lower layer links 591 are sidelink channels. Remote UE 561 also has PC5-SRAP layer 581 between RLC layer and PDCP layer. PC5-SRAP at remote UE 561 supports UL bearer mapping between remote UE Uu Radio Bearer and egress PC5 RLC channels. Relay UE 563 has a PC5-SRAP 582 connecting to remote UE 561 PC5-SRAP 581, and an Uu-SRAP 583 connecting to gNB Uu-SRAP 584. On the control plane, end-to-end protocol connection is established directly between protocol stack at RRC and PDCP layer.

In order to enable multiple paths (including two paths) for data transmission, it can establish both direct path and indirect path(s) between source node and destination node. Alternatively, only two or more than two indirect paths can be established between the source node and the destination node. Direct path can be defined as a type of transmission path, where data is transmitted between the source node and the destination node without relaying. Indirect path can be defined as a type of transmission path, where data is forwarded via at least one relay node (either a UE, or a base station type node, e.g., an IAB node) between the source node and the destination node. In case of the one-hop UE-to-Network (U2N) relay, the indirect path is the UE-to-Network transmission path, where data is forwarded via a U2N relay UE between a U2N remote UE and the network.

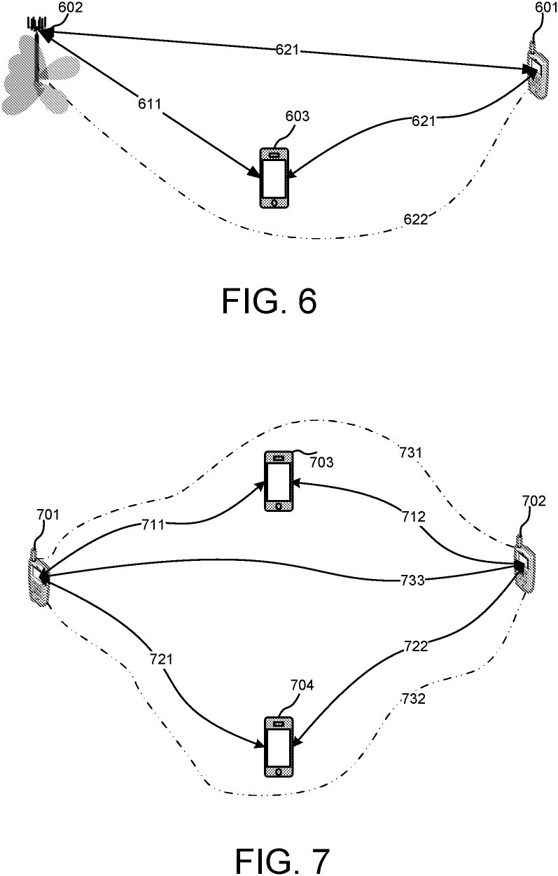

FIG. 6 illustrates exemplary diagrams of a UE-to-Network relay network with multiple paths in accordance with embodiments of the current invention. A remote UE 601 established a relay path with a gNB 602 through a relay UE 603. Relay UE 603 communicates with gNB 602 via access link 611. Relay UE 603 communicates with remote UE 601 through sidelink 612. The sidelink is 3GPP specified radio link with PC5 interface. gNB 602 transmits data packets destined to remote UE 601 through DL to relay UE 603 and receives data packets from remote UE 601 through UL from relay UE 603. The indirect path 622 between remote UE 601 and gNB 602 includes access link 611 and sidelink 612. A direct link 621 between remote UE 601 and gNB 602 is also established. Remote UE 601 is configured with multipath data communication with gNB 602.

In order to prepare for multiple transmission paths based data transmission, remote UE 601 can establish the direct path with the network at the first place. Subsequently, remote UE 601 may report the presence of one or a plural of candidate relay UEs via Uu RRC message (e.g., Measurement Report message) to the gNB 602. Upon receiving the measurement reports, gNB 602 takes the decision to add the indirect path in response to this message. The Uu RRC message to request to add the indirect transmission path can be transmitted over direct path. The network can configure remote UE 601 and relay UE 603 to establish the relaying link to enable the indirect path. In other scenarios, the remote UE 601 establishes the indirect path with the network first. Subsequently, remote UE 601 requests the network to add the direct transmission path via Uu RRC message (e.g., via Measurement Report message) when the remote UE 601 moves from out of coverage area to in-coverage area. In other scenarios (not shown), the remote UE 601 can establish the first indirect path with the network first. Subsequently, UE 601 requests the network to add the second indirect transmission path via Uu RRC message. The Uu RRC message to request to add the second indirect transmission path can be transmitted over the first indirect path. Then the network can configure the remote UE and the relay UE to establish the second indirect relaying link to enable the indirect path. During multiple path operation, the remote UE can release the indirect path or release the direct path depending on the need or according to the signal strength of the path. The remote UE can change the serving cell for the direct path while keeping the serving relay UE for the indirect path under the same gNB. The remote UE can keep the serving relay UE for the indirect path and the serving cell of the remote UE for the direct path while the serving relay UE changes the serving cell of the relay UE under the same gNB. The remote UE can change to a new relay UE for the indirect path while keeping the direct path under the same gNB.

FIG. 7 illustrates exemplary diagrams of a UE-to-UE relay network with multiple paths in accordance with embodiments of the current invention. There are two relay UEs, relay UE 703 and relay UE 704, located between the remote UE 701 and the remote UE 702. Relay UE 703 and relay UE 704 work at L2 relaying mode. Sidelink 711 is established between source node 701 and relay node 703. Sidelink 712 is established between destination node 702 and relay node 703. Indirect path 731 includes sidelink 711 and sidelink 712. Sidelink 721 is established between source node 701 and relay node 704. Sidelink 722 is established between destination node 702 and relay node 704. Indirect path 732 includes sidelink 721 and sidelink 722. Two relay paths/indirect paths are established. A direct path 733 is established with PC5 sidelink between the source node/remote UE 701 and the destination node/remote UE 702. In one example, remote UE 701 establishes the direct path 733 with remote UE 702 first. Subsequently, remote UE 701 requests the remote UE 702 to add one or a plural of indirect transmission path via PC5 RRC message. The PC5 RRC message to request to add the indirect transmission path(s) is transmitted over direct path. Alternatively, remote UE 701 establishes one or more indirect paths with remote UE 702 first. Subsequently, remote UE 701 requests the remote UE 702 to add the direct transmission path 733 via PC5 RRC message. In other scenarios, remote UE 702 establishes the first indirect path, such as indirect path 731, with remote UE 702 first. Subsequently, remote UE 701 requests remote UE 702 to add the second indirect transmission path, such as indirect path 732, via PC5 RRC message, when there is no direct path. When there is no direct path available, the PC5 RRC message to request to add the second indirect transmission path is transmitted over the first indirect path.

The indirect paths described at FIG. 6 and FIG. 7 are only one-hop based indirect path, where there is only one relay node in between. In other scenarios, as illustrated in FIG. 1, the indirect path can also cross more than one relay node in multi-hop relaying environment and the relay node can be relay UE or gNB, or an IAB node as specified by 3GPP. In a multi-hop relaying network, a mesh type communication is implemented based on multiple transmission paths. In this invention, when the data transmission mechanism is described for the scenarios as depicted at FIG. 6 and FIG. 7, the same or similar mechanism may be applicable to other scenarios.

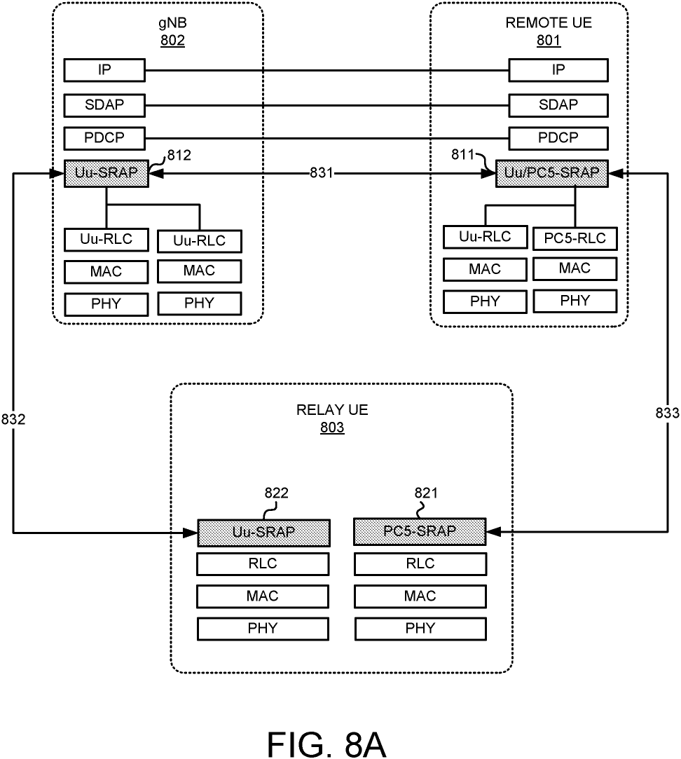

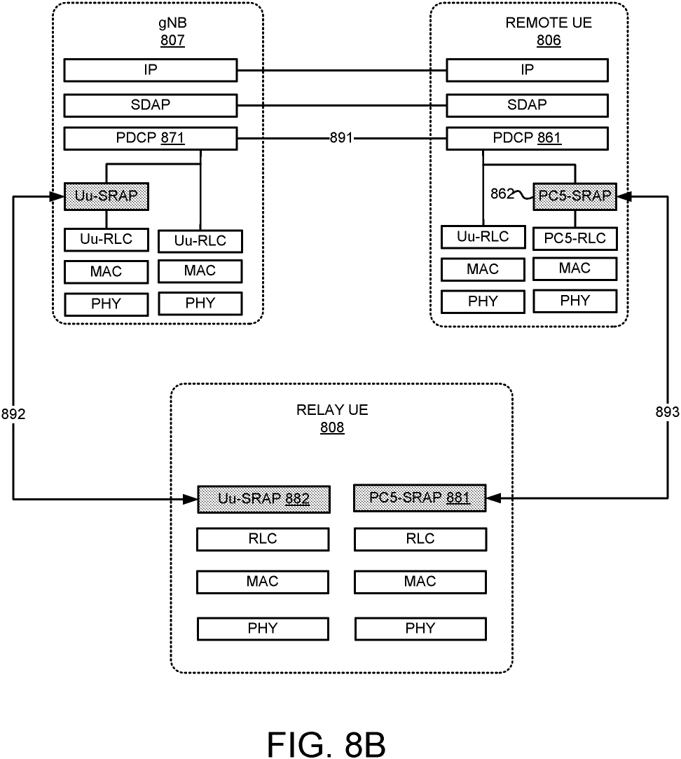

FIG. 8A illustrates exemplary diagrams for UE-to-Network relay network with multiple paths where the data split and/or data aggregation being performed at the SRAP sublayer in accordance with embodiments of the current invention. In FIG. 8A, A remote UE 801 established a direct link/path 831 with a gNB 802. Remote UE 802 also establishes an indirectly path through a sidelink 833 with a relay UE 803, which has an Uu link 832 with gNB 802. An SRAP entity 811 at remote UE 802 is associated with two RLC entities specific to the data transmission for the remote UE, one is an Uu RLC entity corresponding to the direct path and the other is a PC5 RLC entity corresponding to the indirect path. SRAP sublayer 811 may implement both Uu SRAP sublayer and PC5 SRAP sublayer functions, since this SRAP sublayer needs to communicate with the peer Uu SRAP sublayer 812 at gNB 802 and the peer PC5 SRAP sublayer 821 at relay UE 803. In one embodiment, SRAP sublayer at remote UE 801 may include one Uu SRAP and one PC5 SRAP entity separately. In another embodiment, remote UE 801 only includes one common SRAP entity 811 serving both Uu interface and PC5 interface. The SRAP entity serves for the traffic that may go to the gNB and one or more Relay UEs. Relay UE 803 is configured with one PC5 SRAP entity 821 and one Uu SRAP entity 822 for uplink and downlink data, each associated with a RLC entity (one is PC5 RLC entity and the other is Uu RLC entity), specific to the data transmission for remote UE 801. At relay UE 803, the SRAP sublayer may implement both Uu SRAP sublayer and PC5 SRAP sublayer, since this SRAP sublayer needs to communicate with the peer Uu SRAP sublayer 812 at gNB 802 and the peer PC5 SRAP sublayer 811 at remote UE 801. In other embodiments, the SRAP sublayer at relay UE 803 includes one Uu SRAP 822 and one PC5 SRAP entity 821, or only include one common SRAP entity (not shown) serving both Uu interface and PC5 interface. gNB 802 establishes one Uu SRAP sublayer 812 (corresponding to one SRAP entity) that serves for one or multiple remote UE(s) and/or relay UE(s). SRAP sublayer 812 is responsible for data transmission and/or data reception.

If there is uplink data sourced from remote UE 801, it is delivered by the PDCP sublayer to SRAP sublayer 811. After receiving the data from PDCP, if the data split is activated, the SRAP sublayer 811 splits the data flow and delivers the data packets to Uu RLC entity and PC5 RLC entity. The said data packets for split can be SRAP Data PDU, or the data corresponding to the PDCP Data PDU. In case of SRAP Data PDU, it may include both PDCP Data PDU and PDCP Control PDU. After receiving the data from PDCP, if the data duplication is activated, the SRAP sublayer 811 duplicates the data flow and delivers the data packets to Uu RLC entity and PC5 RLC entity. The said data packets for duplication can be SRAP Data PDU, or the data corresponding to the PDCP Data PDU. In case of SRAP Data PDU for duplication, it may include both PDCP Data PDU and PDCP Control PDU.

In one novel aspect, one primary path and one or more secondary paths are configured for the multipath data transceiving. Accordingly, a primary RLC entity and one or more secondary RLC entities are configured for remote UE 801. In one embodiment, remote UE 801 performs data split or data duplication based on preconfigured threshold. For uplink data, the SRAP sublayer 811 can submit the SRAP data (e.g., SRAP PDU) to either the primary RLC entity or the secondary RLC entity, if the total amount of SRAP data volume and RLC data volume pending for initial transmission in the two associated RLC entities is equal to or larger than a preconfigured/ predefined threshold. The SRAP sublayer 811 can submit the SRAP data (e.g., SRAP PDU) only to the primary RLC entity if the total amount of SRAP data volume and RLC data volume pending for initial transmission in the two associated RLC entities is smaller than a preconfigured/ predefined threshold. When the transmitting SRAP sublayer is associated with two RLC entities at remote UE 801, in one embodiment, UE 801 minimizes the amount of SRAP data submitted to lower layers before receiving request from lower layers and minimize the gap between SRAP PDUs submitted to two associated RLC entities to minimize PDCP reordering delay in the receiving PDCP entity.

For uplink data, when the PC5 SRAP sublayer 821 at relay UE 803 receives the data from the remote UE 801, relay UE 803 submits the PC5 SRAP data to Uu SRAP sublayer 822 for transmission. If PC5 SRAP 821 and Uu SRAP 822 are implemented as one sublayer at relay UE 803, relay UE 803 just delivers the data received from the ingress sidelink RLC channel from remote UE 801 to egress Uu RLC channel to gNB 802 over the Uu interface. In one implementation, relay UE 803 may perform bearer mapping as legacy operation (specified by 3GPP Rel-17 for sidelink relay), i.e., the data coming from multiple remote UEs may be multiplexed by relay UE 803 when the data is delivered over the Uu RLC channel. For uplink data, when the Uu SRAP sublayer 812 at gNB 802 receives the data from the remote UE 801 and the data from relay UE 803, gNB 802 submits the SRAP data to its PDCP sublayer.

Downlink data sourced from gNB 802 is delivered by the PDCP sublayer to SRAP sublayer 812. After receiving the data from PDCP, if the data split is activated, the SRAP sublayer 812 at gNB 802 can split the data flow and delivers the data packets to the Uu RLC entity corresponding to remote UE 801 and the Uu RLC entity corresponding to relay UE 803. The said data packets can be SRAP Data PDU, or the data corresponding to the PDCP Data PDU. In case of SRAP Data PDU, it may include both PDCP Data PDU and PDCP Control PDU. After receiving the data from PDCP, if the data duplication is activated, the SRAP sublayer 812 at gNB 802 can duplicate the data flow and delivers the data packets to the Uu RLC entity corresponding to remote UE 801 and the Uu RLC entity corresponding to relay UE 803. The said data packets can be SRAP Data PDU, or the data corresponding to the PDCP Data PDU. In case of SRAP Data PDU, it may include both PDCP Data PDU and PDCP Control PDU. There are two associated Uu RLC entities for the SRAP sublayer 812 at gNB 802, one of the RLC entities can be the primary RLC entity and one of the RLC entities can be the secondary RLC entity. The transmitting SRAP sublayer 812 at gNB 802, for downlink data, can submit the SRAP Control PDU only to the primary RLC entity by implementation. On top of that, the transmitting SRAP sublayer 812 at gNB 802 can also submit the SRAP Data PDU corresponding to PDCP Control PDU only to the primary RLC entity by implementation. In this case the PDCP sublayer at gNB 802 needs to mark the PDCP Control PDU to SRAP sublayer 812.

For downlink data, when the PC5 SRAP sublayer 821 at relay UE 803 receives the data from the gNB 802, relay UE 803 submits the Uu SRAP data to PC5 SRAP sublayer 821. If PC5 SRAP 821 and Uu SRAP 822 are implemented as one sublayer at relay UE 803, relay UE 803 just delivers the data received from the ingress Uu RLC channel from gNB 802 to egress PC5 (i.e., sidelink) RLC channel to remote UE 801 over the PC5 interface. In some implementations, relay UE 803 may perform bearer mapping, i.e., the data coming from gNB and the data coming other relay UEs may be multiplexed by relay UE 803 when the data is delivered over the PC5 RLC channel going to remote UE 801. For downlink data, when the Uu/PC5 SRAP sublayer 811 at remote UE 801 receives the data from the relay UE 803 and the data from gNB 802, remote UE 801 aggregates data and submits the SRAP data to PDCP sublayer sequentially. The Uu/PC5 SRAP sublayer 811 at remote UE 801 is not responsible for in order delivery for the data packets when the data packets are delivered to PDCP sublayer since it only performs first in first out policy. The PDCP sublayer at remote UE 801 needs to perform data reordering, duplicated packets detection and necessary data retransmissions as done by legacy PDCP.

FIG. 8B illustrates exemplary diagrams for UE-to-Network relay network with multiple paths where the data split and/or data aggregation being performed at the PDCP sublayer in accordance with embodiments of the current invention. A remote UE 806 established a direct link/path 891 with a gNB 807. Remote UE 806 also establishes an indirectly path through a sidelink 893 with a relay UE 808, which has an Uu link 892 with gNB. During multiple path operation, direct radio bearer, indirect radio bearer and multiple path split radio bearer can be configured between remote UE 806 and gNB 807. For the multiple path split radio bearer, one PDCP entity 861 at remote UE 806 is configured with association towards one direct Uu RLC channel and one indirect PC5 RLC channel. For upstream, PDCP entity 861 delivers the data to a PC5 RLC entity with SRAP entity 862 in the remote UE side. PDCP entity 861 may delivers the data directly to a Uu RLC entity. For downstream, PDCP entity 861 receives the data from a PC5 RLC entity with SRAP entity 862 in the remote UE side. The PDCP entity 861 may receives the data directly from a Uu RLC entity. If there is uplink data sourced from remote UE 806, it is delivered from upper layer to the PDCP sublayer 861, which will perform data split and/or data duplication for the multiple path split radio bearer. The multiple path split radio bearer can be data radio bearer (DRB) or signaling radio bearer (SRB).

In one embodiment, for uplink data, when the PC5 SRAP sublayer 881 at relay UE 808 receives the data from the remote UE 806, relay UE 808 submits PC5 SRAP sublayer data PDU to Uu SRAP sublayer 882 for transmission. For uplink data, when the PDCP sublayer 871 at gNB 807 receives the data from the remote UE 806 and the data from relay UE 808, gNB 807 submits the PDCP data to upper layers. For downlink data, when the Uu SRAP sublayer 882 at relay UE 808 receives the data from the gNB 807, relay UE 808 submits to the PC5 SRAP sublayer 881. In some implementations, relay UE 808 may perform bearer mapping, i.e., the data coming from gNB and the data coming other relay UEs may be multiplexed by relay UE 808 when the data is delivered over the PC5 RLC channel going to remote UE 806. For downlink data, when the PDCP 861 at remote UE 806 receives the data from the relay UE 808 and the data from gNB 807, remote UE 806 aggregates data and submits the PDCP data to upper layers sequentially. The Uu/PC5 SRAP sublayer 862 at remote UE 806 is not responsible for in order delivery for the data packets when the data packets are delivered to PDCP sublayer since it only performs first in first out policy. The PDCP sublayer 861 at remote UE 806 needs to perform data reordering, duplicated packets detection and necessary data retransmissions as done by legacy PDCP.

In one novel aspect, one primary path and one or more secondary paths are configured for the multipath data transceiving. Accordingly, a primary RLC entity and one or more secondary RLC entities are configured for remote UE 806. In one embodiment, remote UE 806 performs data split or data duplication based on preconfigured threshold. For uplink data, the PDCP sublayer can submit the data to either the primary RLC entity or the secondary RLC entity, if the total amount of data volume pending for initial transmission in the two associated RLC entities is equal to or larger than a preconfigured/ predefined threshold. The PDCP sublayer can submit the data only to the primary RLC entity if the total amount of data volume pending for initial transmission is smaller than a preconfigured/ predefined threshold. From Remote UE perspective, there is a single MAC entity to support the data transceiving for both direct path and indirect path.

For PDCP based data split and/or duplication, the RLC entities of the multiple paths should have the same RLC transmission mode. RRC message may be used to configure the PDCP based data split and/or duplication for a particular radio bearer. The MAC CE can be used to control the activation and deactivation of such PDCP based data split and/or duplication for multiple path relay operation. Such MAC CE can be transmitted via direct link or the primary path. When one RLC entity (at direct path or indirect path) acknowledges the transmission of a PDCP PDU, the PDCP entity can indicate to the other RLC entity (at direct path or indirect path) to discard it.

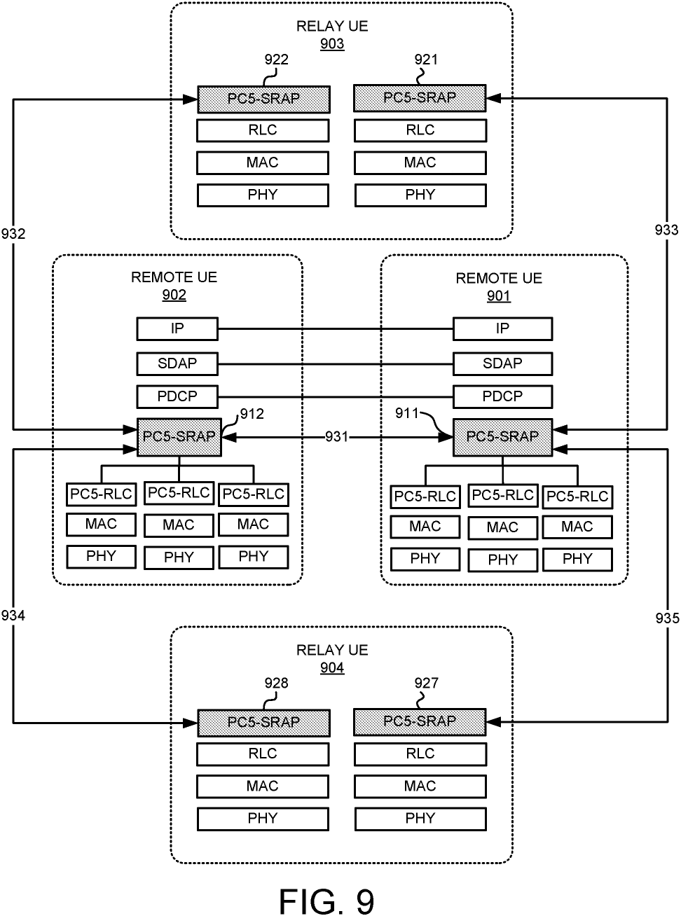

FIG. 9 illustrates exemplary diagrams for UE-to-UE relay network with multiple paths in accordance with embodiments of the current invention. A remote UE 901 has a direct link 931 with a remote UE 902. A first indirect path between remote UE 901 and remote UE 902 includes a sidelink 933 between remote UE 901 and relay UE 903, and a sidelink 932 between relay UE 903 and remote UE 902. A second indirect path between remote UE 901 and remote UE 902 includes a sidelink 935 between remote UE 901 and relay UE 904, and a sidelink 934 between relay UE 904 and remote UE 902. There is one receiving PC5 SRAP entity 921 and one transmitting PC5 SRAP entity 922 at relay UE 903. There is one receiving PC5 SRAP entity 927 and one transmitting PC5 SRAP entity 928 at relay UE 904. Each SRAP entity of the relay UEs is associated with a PC5 RLC entity, specific to the data transmission for remote UEs 901 and 902. At relay UEs 903 and 904, the SRAP sublayers may implement two PC5 SRAP sublayers, since this SRAP sublayer needs to communicate with the peer PC5 SRAP sublayer at the source node remote UE and the peer PC5 SRAP sublayer at the destination node remote UE. SRAP sublayer at relay UEs 903 and 904, each includes two PC5 SRAP entities or only include one common SRAP entity serving the two PC5 interfaces. All the SRAP sublayer can be responsible for data transmission and data reception.

In the exemplary configuration shown, remote UE 901 is configured with three data transceiving paths with remote UE 902. The data transmission between remote UE 901 and 902 is delivered by the PDCP sublayer to SRAP sublayer as a PDCP Data PDU. After receiving the data from PDCP, if the data split is activated, the SRAP sublayer 911 at remote UE 901 splits the data flow and delivers the data packets to three PC5 RLC entities. The said data packets can be SRAP Data PDU, or the data corresponding to the PDCP Data PDU. In case of SRAP Data PDU, it may include both PDCP Data PDU and PDCP Control PDU. After receiving the data from PDCP, if the data duplication is activated, the SRAP sublayer 911 at remote UE 901 can duplicate the data flow and delivers the data packets to three PC5 RLC entities. The said data packets can be SRAP Data PDU, or the data corresponding to the PDCP Data PDU. In case of SRAP Data PDU, it may include both PDCP Data PDU and PDCP Control PDU.

There are three associated RLC entities for the SRAP sublayer at remote UE 901 and remote UE 902. One of the PC5 RLC entities of each remote UE can be configured as the primary RLC entity (corresponding to a primary link/path) and the other RLC entities can be configured as the secondary RLC entities (corresponding to secondary links/paths). The transmitting SRAP sublayers 911 and 912 at remote UE 901 and remote UE 902, respectively, for transmitted data, can submit the SRAP Control PDU only to the primary RLC entity if configured or by default. On top of that, the transmitting SRAP sublayer at remote UEs 901 and 902 can also submit the SRAP Data PDU corresponding to and PDCP Control PDU only to the primary RLC entity if configured or by default. In this case the PDCP sublayers at remote UE 901 and remote UE 902 need to mark the PDCP Control PDU to SRAP sublayer.

For data transmission, the SRAP sublayer at remote UE 901 and remote UE 902 can submit the SRAP data (e.g., SRAP PDU) to either the primary RLC entity or the secondary RLC entity, if the total amount of SRAP data volume and RLC data volume pending for initial transmission in the three associated RLC entities is equal to or larger than a preconfigured / predefined threshold. The SRAP sublayer at remote UE 901 and remote UE 902 can submit the SRAP data (e.g., SRAP PDU) only to the primary RLC entity if the total amount of SRAP data volume and RLC data volume pending for initial transmission in the three associated RLC entities is smaller than a preconfigured / predefined threshold. When the transmitting SRAP sublayer is associated with two or multiple RLC entities at remote UE 901 and/or remote UE 902, the UE(s) should minimize the amount of SRAP data submitted to lower layers before receiving request from lower layers and minimize the gap between SRAP PDUs submitted to the associated RLC entities to minimize PDCP reordering delay in the receiving PDCP entity.

For data transmission, when the PC5 SRAP sublayer at relay UE 903 and relay UE 904 receive the data from the remote UE 901 and/or remote UE 902, the relay UE(s) delivers the data received from the ingress sidelink RLC channel from the remote UE to egress PC5 RLC channel to another remote UE over the PC5 interface(s). In some implementation, relay UE 903 and relay UE 904 may perform bearer mapping as legacy operation (specified by 3GPP Rel-17 for sidelink relay), i.e., the data coming from multiple remote UEs may be multiplexed by the relay UEs when the data are delivered over the egress PC5 RLC channel. When the PC5 SRAP sublayer at recipient (either remote UE 901 or remote UE 902) receives the data from multiple paths including from its peer remote UE through the direct path, and the data from relay UEs through the indirect paths, it submits the SRAP data to PDCP sublayer at First In First Out manner. When the PC5 SRAP sublayers 911 and 912 at remote UE 901 and remote UE 902, respectively, receives the data from one or more relay UEs, or from its peer remote UE, the receiving remote UE aggregates the data and submits the SRAP data to PDCP sublayer sequentially. The PC5 SRAP sublayer at the receiving remote UE is not responsible for in order delivery for the data packets when the data packets is delivered to PDCP sublayer since it only perform first in first out policy. Then the PDCP sublayer at the receiving Remote UE needs to perform data reordering, duplicated packets detection and necessary data retransmissions as done by legacy PDCP.

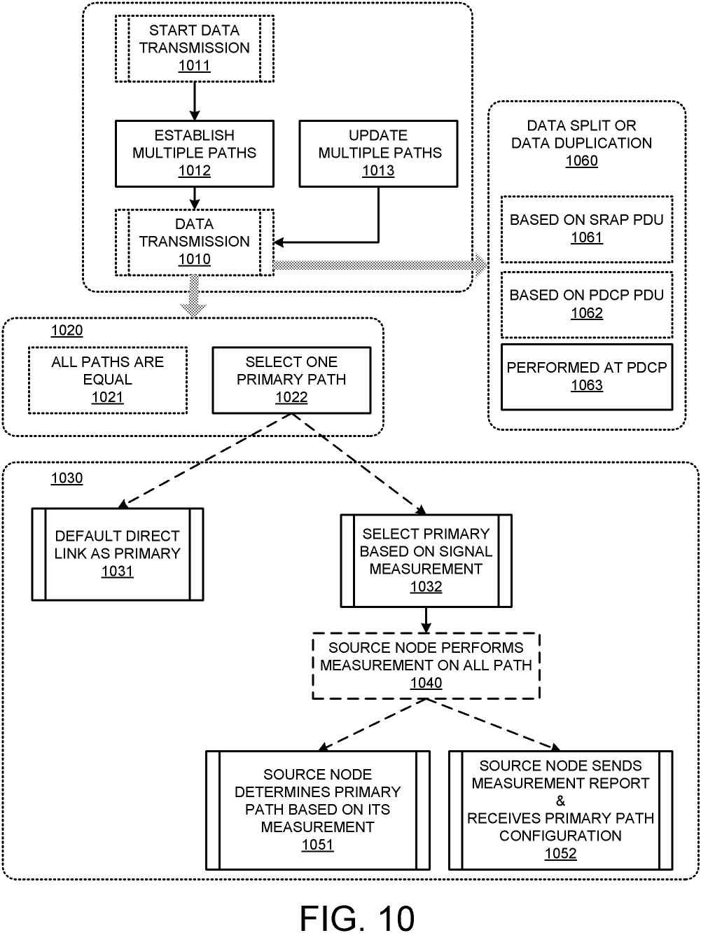

FIG. 10 illustrates an exemplary diagram for alternative implementations to configure sidelink relay based multipath data transmission in accordance with embodiments of the current invention. In one novel aspect, multiple paths including at least one sidelink relay path is configured for multipath data transmission. The configuration of the multipath can start before or after the data transmission. Before the actual data transmission, the source node (i.e., transmitting node) needs to establish multiple transmission paths with the destination node. In one scenario, at step 1011, data transmission starts with one path. At step 1012, multiple paths are configured for this data transmission. Alternatively, the source node (i.e., transmitting node) can add one more transmission path when the source node performs data transmission with the destination but find the need to introduce multiple transmission paths or add one or more paths on top of the available multiple transmission paths. The data transmission at step 1011 is configured with multiple paths and at step 1013, the multipath configuration is updated. In another scenario, data transmission 1010 does not start until the multiple paths are configured.

With multipath configured for the data transmission, multiple RLC entities are configured with the associated the SRAP sublayer at the remote UE. Each RLC entity is corresponding to one transmission path, and/or (RLC) transmission link (or link for simplicity). Alternative configuration 1020 can be implemented and/or preconfigured. In one implementation 1021, from transmission perspective, the available transmission paths or links from the source node (e.g., the remote UE) to the destination node (e.g., another remote UE) can be equivalent or equally important. There is no primary path and no secondary path at all. Alternatively, in implementation 1022, one of the available transmission paths or link can defined as the primary path or primary link, and the other one(s) can be defined as the secondary path(s) or secondary link(s). In this case 1030, correspondingly, one of the RLC entities (either Uu RLC entity or PC5 RLC entity) can be configured as the primary RLC entity and the other RLC entities (either Uu RLC entity or PC5 RLC entity) can be configured as the secondary RLC entities. It is also possible that there is only one secondary RLC entity.

For configuration 1030, a primary path is selected. When there are multiple transmission paths available including direct path and indirect paths, the path quality may be different. Among the wireless links corresponding to the multiple transmission paths, one can be selected by the UE or configured by the network as the primary link or primary transmission path and the other one(s) can be selected by the UE or configured by the network as secondary link or secondary transmission path. One way for such selection or configuration, as alternative 1031, is that the direct path is always selected or configured as the primary path and the other path(s) is always selected or configured as the secondary path. For example, in case of UE-to-Network relaying architecture, the network can configure the direct path via Uu RRC connection to the Remote UE as the primary path. Another way, as alternative 1032, for such selection or configuration is that the link with the best signal quality is selected or configured as the primary path and the other path(s) with less strong signal can be selected or configured as the secondary path(s).

When the primary path is selected based on signal measurement, in one implementation 1040, the source node performs measurements. In one alternative 1051, the source node that performs the measurement selects the primary path based on its own measurement and possibly other measurements received from other entity. In another alternative 1052, the source node, optionally, sends the measurement report. In alternative 1052, the source node receives primary path configuration. For example, in case of UE-to-UE relaying architecture, one remote UE can select the direct path as the primary path and send its selection via PC5 RRC message to another Remote UE. Alternatively, a remote UE may perform quality measurements (for instance, radio measurements) relative to the multiple transmission paths and send the results to the network (in case of UE-to-Network relaying) or the peer Remote UE (in case of UE-to-UE relaying) to assist the peer node (network or peer Remote UE) in selecting the primary path.

In case of UE-to-UE relaying architecture, signal quality of different PC5 links corresponding to each PC5 transmission path can be compared with each other and then the strongest link is the best signal quality link. Such comparison can be performed based on the SL-RSRP and/or SD-RSRP over the corresponding PC5 link. In case of UE-to-UE relaying architecture, PC5 RRC message(s) may be used to align the selection of the primary link and secondary links between peer Remote UEs i.e., between the source node and the destination node for data transmission. For example, if one node selects one transmission path as the primary link for data transmission, the peer node can follow the selection as well. The selection of the primary link and secondary links between the peer nodes may be subject to dynamic update depending on the different factors, e.g., the changing wireless signal strength (e.g., SL-RSRP and or SD-RSRP) over the corresponding PC5 link or data transmission failure rate. In case of UE-to-UE relaying architecture, the transmitting SRAP sublayer at the remote UE can submit the SRAP Control PDU only to the primary RLC entity if configured or by default.

In case of UE-to-Network relaying architecture, if there is no direct path, signal quality of different indirect links corresponding to the transmission path can be compared with each other among indirect paths, and then the strongest indirect path with the best signal quality link can be selected as the primary path. Such comparison can be performed based on the RSRP over the corresponding PC5 links as measured by Remote UE. Remote UE can report the measurements to the network, the network can select the primary path based on measurements from the Remote UE, measurements from the plurality of Relay UEs corresponding to the plurality of indirect links, or a combination. And then the network configures the primary path and secondary path(s). Alternatively, Remote UE can select the primary path and report his selection to the network. In case of UE-to-Network relaying architecture, the transmitting SRAP sublayer at Remote UE, for uplink data, can submit the SRAP Control PDU only to the primary RLC entity if configured or by default. On top of that, the transmitting SRAP sublayer at Remote UE can also submit the SRAP Data PDU corresponding to the PDCP Control PDU only to the primary RLC entity if configured or by default. In this case the PDCP sublayer at Remote UE needs to mark the PDCP Control PDU to SRAP sublayer.

There are different alternatives for data split or data duplication 1060. In embodiment 1061, the data split and/or data duplication is performed at SRAP layer based on SRAP PDUs. In embodiment 1062, the data split and/or data duplication is performed at SRAP layer based on PDCP PDUs. During data split or data duplication, the source node can always deliver the SRAP control PDU to the destination node through the primary path. This means the SRAP control PDU may never be transmitted by secondary path(s). When the data packets (e.g., SRAP data PDU) is split or duplicated by SRAP sublayer, the data is sent from transmitting node to receiving node via different transmission paths, including two or more paths, independently. The SRAP sublayer of the receiving node (e.g., the UE, or the base station) delivers the received data packets to the PDCP sublayer, and then PDCP sublayer performs data combination, duplicates removal, and/or reordering. The SRAP may reuse the same packet header as the SRAP protocol as specified by 3GPP R17 for sidelink relay. This means the SRAP mainly includes D/C region, R bits, (local) UE ID and RB ID. The SRAP functionality may reuse the bearer mapping functionality as specified by Rel-17 SRAP. Even though the said data split or data duplication is performed at transmitted SRAP sublayer, the data split or data duplication operation is actually performed based on PDCP PDU, since the SRAP sublayer does not concatenate the data from PDCP or do segmentation on the data from PDCP. Accordingly, even though the aggregation is performed at receiving SRAP sublayer, the receiving SRAP sublayer does not detect the data loss, do duplication removal or reordering, since these functions still are supported at PDCP sublayer.

Alternatively, in embodiment 1063, the said data split or data duplication can be performed at transmitting PDCP sublayer, and the data combination and aggregation is performed at the receiving PDCP sublayer as well. The methods described above for SRAP based data split or data duplication are applied.

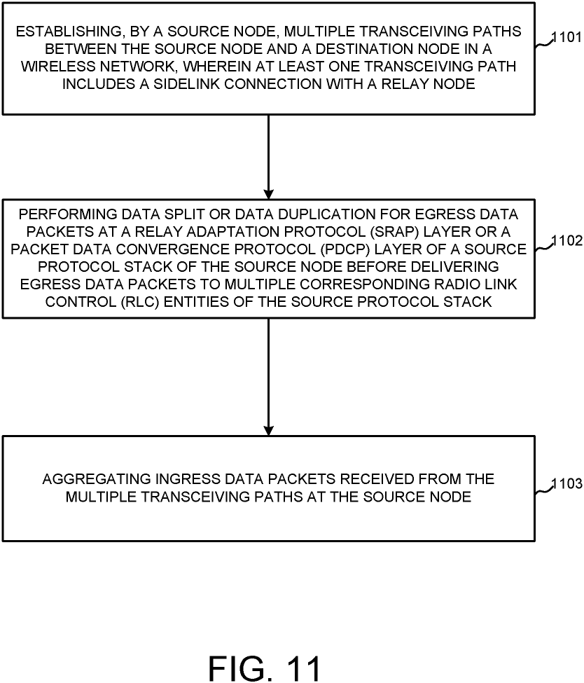

FIG. 11 illustrates an exemplary flow chart for the sidelink relay based data transmission with multiple paths in accordance with embodiments of the current invention. At step 1101, the source node establishes multiple transceiving paths between the source node and a destination node in a wireless network, wherein at least one transceiving path includes a sidelink connection with a relay node. At step 1102, the source node performs data split or data duplication for egress data packets at a sidelink relay adaptation protocol (SRAP) layer or PDCP layer of a source protocol stack of the source node before delivering egress data packets to multiple corresponding radio link control (RLC) entities of the source protocol stack. At step 1103, the source node aggregates ingress data packets received from the multiple transceiving paths.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
establishing, by a source node, multiple transceiving paths between the source node and a destination node in a wireless network, wherein at least one transceiving path includes a sidelink connection with a relay node;
performing data split or data duplication for egress data packets at a sidelink relay adaptation protocol (SRAP) layer or a packet data convergence protocol (PDCP) layer of a source protocol stack of the source node before delivering egress data packets to multiple corresponding radio link control (RLC) entities of the source protocol stack; and
aggregating ingress data packets received from the multiple transceiving paths at the source node.

2. The method of claim 1, wherein the multiple transceiving paths are established before a start of data transmission between the source node and the destination node.

3. The method of claim 2, further comprising: selecting one transceiving path among the multiple transceiving paths as a primary path.

4. The method of claim 3, wherein a direct path between the source node and the destination node or a first established path between the source node and the destination node is selected as the primary path.

5. The method of claim 3, wherein the primary path is selected based signal qualities of the multiple transceiving paths.

6. The method of claim 5, wherein the source node performs signal measurements of the multiple transceiving paths and selects the primary path based on its own measurements.

7. The method of claim 5, wherein the source node receives a configuration indicating a path as the primary path from the destination node.

8. The method of claim 7, wherein the source node sends signal measurements of the multiple transceiving paths to the destination node, and wherein the primary path is selected based on signal measurements of the source node.

9. The method of claim 3, wherein the source node and the destination node are user equipments (UEs), and wherein PC5 messages are used to align the primary path between the source node and the destination node.

10. The method of claim 3, wherein the primary path is dynamically updated.

11. The method of claim 3, wherein SRAP control packet data units (PDUs) are transmitted through the primary path.

12. The method of claim 1, wherein the source node performs data split or data duplication at the SRAP layer per packet or per resource block (RB).

13. The method of claim 12, wherein the source node performs data split or data duplication based on a preconfigured threshold.

14. The method of claim 12, wherein the source node performs data split or data duplication based on SRAP data PDU or packet data convergence protocol (PDCP) data PDU.

15. A user equipment (UE), comprising:
a transceiver that transmits and receives radio frequency (RF) signal in a wireless network;
a multi-path module that establishes multiple transceiving paths between the UE and a destination node in the wireless network, wherein at least one transceiving path includes a sidelink connection with a relay node;
a data module that performs data split or data duplication at sidelink relay adaptation protocol (SRAP) layer or packet data convergence protocol (PDCP) layer for egress data packets before delivering egress data packets to multiple corresponding radio link control (RLC) entities of a source protocol stack of the UE; and
an aggregation module that aggregates ingress data packets received from the multiple transceiving paths.

16. The UE of claim 15, further comprising: a path-selection module that selects one transceiving path among the multiple transceiving paths as a primary path.

17. The UE of claim 16, wherein a direct path between the UE and the destination node or a first established path between the UE and the destination node is selected as the primary path.

18. The UE of claim 16, wherein the primary path is selected based signal qualities of the multiple transceiving paths.

19. The UE of claim 18, wherein the UE performs signal measurements of the multiple transceiving paths and selects the primary path based on its own measurements.

20. The UE of claim 18, wherein the UE receives a configuration indicating a path as the primary path from the destination node.
